(19) United States
(12) Patent Application Publication
(10) Pub. No.: US 2026/0135846 A1
(43) Pub. Date: May 14, 2026

(54) METHOD FOR GLOBAL IDENTITY VERIFICATION

(71) Applicant: Capital One Services, LLC, McLean, VA (US)

(72) Inventors: Jackson MACOMBER, Henrico, VA (US); Jeffrey RULE, Chevy Chase, MD (US); Lawrence DOUGLAS, McLean, VA (US); Bob Uni KOSHY, Henrico, VA (US)

(73) Assignee: Capital One Services, LLC, McLean, VA (US)

(21) Appl. No.: 19/437,437

(22) Filed: Dec. 31, 2025

Related U.S. Application Data
(63) Continuation of application No. 18/265,567, filed on Jun. 6, 2023, now Pat. No. 12,537,814.
(60) Provisional application No. 63/315,364, filed on Mar. 1, 2022.

(51) Int. Cl. H04L 9/40

(52) U.S. Cl. CPC H04L 63/083; H04L 63/105

(57) ABSTRACT

Disclosed herein are system, method, and computer readable media embodiments for global identity verification of a user for multiple services. In some embodiments, a centralized authentication platform (CAP) may receive a request from an independent service to generate an authentication token for a client device based on authentication performed by the service. The CAP may generate an authentication token of a particular authorization level, based on the method of authentication used by the service. The CAP may send the token to the client device as well as store the token in a database. The CAP may receive a second request from a second, unrelated service to validate the authentication token on the client device. The CAP may validate the token on the client device against the token in the database and send a response to the second service indicating that token validity and authentication level.

### CROSS-REFERENCE TO RELATED APPLICATIONS

This application is a continuation of U.S. Patent Application No. 18/265,567 entitled “Method for Global Identity Verification” filed June 6, 2023, which is a 371 International Application No. PCT/US2023/063494 entitled “Method for Global Identity Verification” filed March 1, 2023, which claims the benefit of U.S. Provisional Application No. 63/315,364 entitled “Method for Global Identity Verification”, filed March 1, 2022, which is herein incorporated by reference in its entirety.

### BACKGROUND

Over the course of a day, a user of mobile banking, ecommerce, and other online services is required to verify their identity numerous times through a variety of authentication processes in order to access their various accounts. This can become tedious and cumbersome, particularly when multifactor authentication is required. Accordingly, it would be beneficial to have a global identity verification platform that allows authentication by a qualifying service to be trusted by other services.

### BRIEF DESCRIPTION OF THE DRAWINGS/FIGURES

The accompanying drawings are incorporated herein and form a part of the specification.

FIG. 1 is an example block diagram illustrating a system for global identity verification, in accordance with some embodiments.

FIG. 2 is a sequence diagram illustrating a process for authenticating a user with a participating service using a centralized authentication platform, in accordance with some embodiments.

FIG. 3 is a sequence diagram illustrating a process for validating authentication of a user for a participating service using a centralized authentication platform, in accordance with some embodiments.

FIG. 4 is a sequence diagram illustrating a process for re-authenticating a user with a participating service using a centralized authentication platform, in accordance with some embodiments.

FIG. 5 is a flowchart illustrating an example method for authenticating a user with a participating service using a centralized authentication platform, in accordance with some embodiments.

FIG. 6 is a flowchart illustrating an example method for validating authentication of a user for a participating service using a centralized authentication platform, in accordance with some embodiments.

FIG. 7 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method, and/or computer program product embodiments, and/or combinations and sub-combinations thereof, for global identity verification of a user through authentication via a centralized authentication platform (CAP).

In some embodiments, the CAP may receive a request from a participating service to generate an authentication token for a client device based on an authentication performed by the service. The request may be prompted by a user attempting to access a user account through the participating service. The request may include a unique device ID for the client device and a method of authentication used to authenticate the user. Upon receiving the request, the CAP may determine an authorization level corresponding to the method of authentication, and generate an authentication token for the client device based on the authorization level. The CAP may additionally generate token information for the authentication token, the token information comprising a token ID, method of authentication, and authorization level provided by the token. The CAP may store the device ID, authentication token, and token information in a database. The CAP may also send the authentication token to the client device. The CAP may send a response to the requesting service indicating that an authentication token has been generated for the client device. Upon receiving an indication that an authentication token has been generated for the client device, the service may send a response to the client device indicating that the user has been authenticated and granted access to the user account.

Embodiments herein shall be described with reference to applications running on the client device. However, a person of skill in the art will appreciate that a similar authentication process would be used for secure websites accessed through a browser or networks requiring a login.

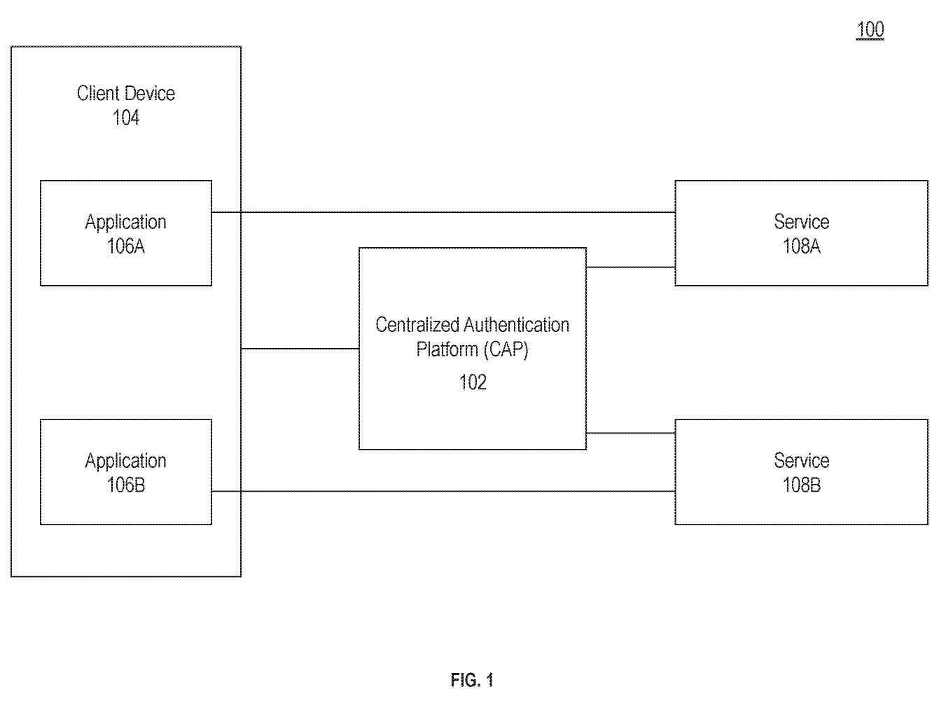

FIG. 1 illustrates a system for global identity verification, in accordance with some embodiments.

In some embodiments, system 100 may include centralized authentication platform (CAP) 102, client device 104 on which applications 106 can be accessed, and services 108. CAP 102 may be an authentication platform responsible for generating, storing, and managing authentication tokens for a plurality of services 108. Services 108 may be online services managed by entities (e.g., banking institutions, merchants, social media networks, etc.) that provide applications 106 through which users can access services 108. In some embodiments, services 108 are separate online services managed by unrelated entities. Services 108 may manage user accounts for a wide range of users. Examples of applications 106 may include mobile, web, desktop, and/or cross-platform applications. In some embodiments, CAP 102 is controlled separately (i.e., is independent) from any one of services 108. In some embodiments, CAP 102 shares control with one or more of services 108, while also being independent from one or more other of services 108.

Services 108 may be configured to require authentication of users before granting access to user accounts via applications 106. Accordingly, services 108 may use CAP 102 to facilitate authentication of users in order to provide a better user experience, by reducing the number of times users have to go through authentication processes while still maintaining the same level of security.

In some embodiments, client device 104 may be a user’s personal device (e.g., smart phone, tablet, laptop, etc.) and have applications 106 (such as 106A and 106B) installed on it. The user may use applications 106 to access services 108 and perform tasks such as view their user accounts, perform transactions, view/update personal information, etc. For example, application 106A may be a mobile ecommerce application managed by service 108A. Service 108A may be an online merchant. The user may have an account with service 108A and use application 106A to access their account and perform a variety of transactions (e.g., make purchases, view order history, track orders, make returns, etc.).

Application 106A may be configured to send a request to service 108A before allowing the user to access their user account and any associated information (e.g., order history, payment information, etc.). The request may include a unique device ID for client device 104 and a flag indicating whether an authentication token from CAP 102 exists on client device 104. Upon receiving the request from application 106A, service 108A may determine, based on the flag, that no authentication token from CAP 102 exists on client device 104. Service 108A may then send a response to application 106A indicating that user authentication is required. The response may include instructions for application 106A to display a login screen to the user. The login screen may instruct the user to provide the credentials necessary for authentication. For example, service 108A may require the user to authenticate by providing the username and password associated with their account in order to access their account. In some embodiments, service 108A may require different methods of authentication to be used for different types of tasks and/or transactions. For example, service 108A may require authentication via username and password login to view their account information, such as their shipping address and order history. However, service 108A may require multifactor authentication for transactions that require a higher level of security such as making purchases and viewing/editing payment information.

Upon receiving the necessary credentials, service 108A may authenticate the user, verifying their identity. Service 108A may send a request to CAP 102 to generate an authentication token to be used by the user on client device 104. The request may include the device ID for client device 104 and the method of authentication used to authenticate the user on client device 104.

In some embodiments, CAP 102 may be configured to generate authentication tokens of different authorization tiers based on the method of authentication. CAP 102 may first validate that the method of authentication provided by service 108A in the request is a qualifying authentication method. Qualifying authentication methods may include username and password login, biometrics, PIN code, physical security key, etc. CAP 102 may then use the authentication method to determine a level of authorization based on the level of security the authentication method provides. For example, authentication via a four-digit code may be assigned a low authorization level, as a four-digit code can be easily stolen or guessed by brute force and thus provides minimal security. Conversely, multifactor authentication methods may be assigned the highest authorization levels as they provide the highest levels of security. The username and password login method used by service 108A may be assigned an authorization level that corresponds to a midlevel of security.

Upon determining the authorization level, CAP 102 may generate an authentication token based on the level of authorization, and send the authentication token to client device 104. Additionally, CAP 102 may store the token in a secure token database along with the device ID for client device 104. CAP 102 may also store token information associated with the authentication token in the token database. The token information may include a token ID, the authorization level, and a timestamp indicating when the token was created. CAP 102 may send a response to service 108A indicating that an authentication token has been generated based on the authentication performed by service 108A and sent to client device 104. Accordingly, service 108A may allow the user to access the user account using application 106A on client device 104.

The user may then open application 106B on client device 104. Application 106B may be a mobile banking application corresponding to service 108B, which may be an online banking service managed by a financial institution. As such, application 106B may be configured to check if there is an authentication token from CAP 102 stored on client device 104 and send a request to service 108B. The request may comprise the device ID for client device 104 and an indication that an authentication token from CAP 102 exists on client device 104.

Service 108B may require authentication of the user in order to allow application 106B access to the user’s banking information. Service 108B may be a participating service that uses CAP 102 to facilitate authentication of users and their devices. Accordingly, upon receiving the request from application 106B, service 108B may send a request to CAP 102 to validate the authentication token on client device 104 and verify the identity of the user based on the authentication token. The request to CAP 102 to validate the token on client device 104 may include the device ID for client device 104.

In some embodiments, CAP 102 may have access to the authentication token stored on client device 104. As such, CAP 102 may validate the authentication token stored on client device 104 against the token for client device 104 stored in CAP 102’s token database. CAP 102 may identify the authentication token for client device 104 in the token database using the unique device ID provided in the request from service 108B. CAP 102 may determine that the authentication token stored on client device 104 matches the authentication token for client device 104 in the token database. In some embodiments, CAP 102 may compare the token ID value for the authentication token on client device 104 with that of the token in the database to determine a match.

Additionally, validation of the authentication token on client device 104 may include determining that the token is still active and has not expired. In some embodiments, service 108B may determine an expiration time after which an authentication token is no longer valid for use with service 108B (i.e., token expiration time). The token expiration time set by service 108B may be based on the authorization level of the authentication token. Alternatively, the token expiration time may be based on the level of authorization required by service 108B for the task the user is attempting to perform in application 106B.

For example, as noted above, application 106B may be a mobile banking application and the request sent from application 106B to service 108B is for access to view the user’s banking information on initial load of application 106B. As such, service 108B may only require a valid token with an authorization level equal to that of a username and password login. Therefore, the service 108B may indicate to CAP 102 that an authentication token must be created within a certain time period (e.g. 48 hours) of the request to validate the token for the token to be trusted by service 108B.

In some embodiments, service 108B may indicate the token expiration time in the request to CAP 102 to validate the authentication token on client device 104. CAP 102 may then determine that the authentication token for client device 104 is valid for authenticating the user with service 108B based on the token expiration time from the request and the timestamp indicating when the token was created.

Alternatively, CAP 102 may maintain a record comprising token expiration times for each participating service based on the token authorization level. CAP 102 may then retrieve the token expiration time data corresponding to service 108B and the authorization level of the authentication token.

Upon determining that the authentication token on client device 104 is active and valid for authenticating the user for service 108B, CAP 102 may send a response to service 108B indicating that the authentication token on client device 104 is valid. Additionally, the response may include the authorization level of the authentication token. Service 108B may determine that the authorization level is sufficient for viewing the user’s banking information and allow access to the user to view their banking information in application 106B on client device 104.

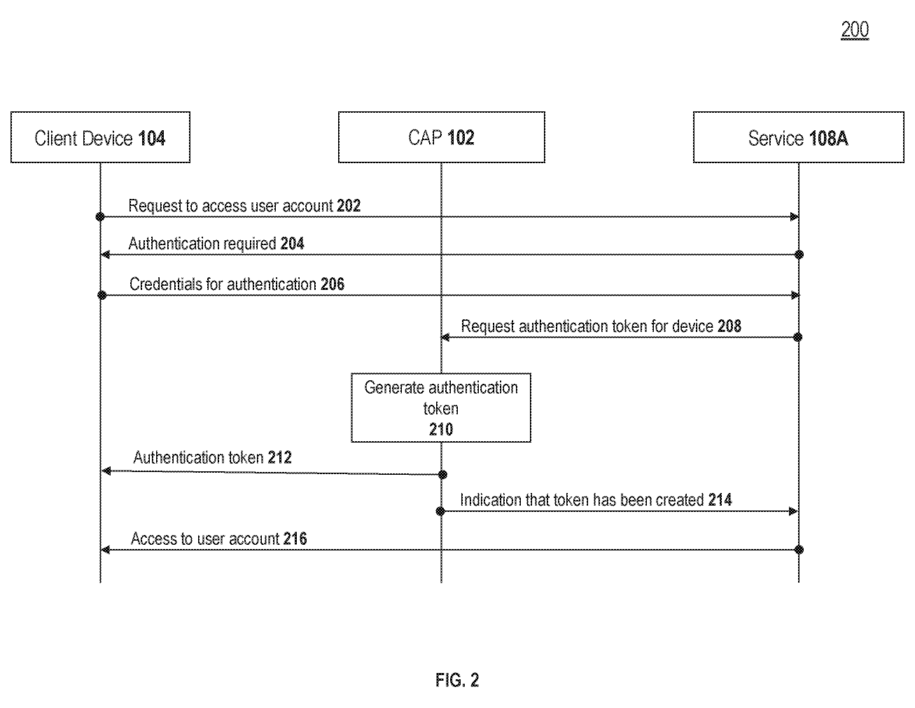

FIG. 2 illustrates a process 200 for authenticating a user with a participating service using a centralized authentication platform (e.g., CAP 102) when no valid token exists on the user device, in accordance with some embodiments. Process 200 may be performed by processing logic that may include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, the steps in FIG. 2 may not need to be performed in the exact order shown, as will be understood by a person of ordinary skill in the art. Accordingly, the scope of the invention should not be considered limited to the specific arrangement of steps shown in FIG. 2.

Process 200 shall be described with reference to FIG. 1. However, process 200 is not limited to that example embodiment.

At 202, application 106A installed on client device 104 may send a request to access a user account to service 108A. The request may include a unique device ID for client device 104. In some embodiments, if the user has not previously logged in to their account with service 108A using application 106A on client device 104, then no user account may be associated with client device 104. Accordingly, the user maybe required to log in to their account and authenticate with service 108A using application 106A.

At 204, service 108A may send a response to application 106A on client device 104 indicating authentication is required to access the user account. The response may include an instruction to provide user credentials for the authentication. Upon receiving the response, application 106A may be configured to display, on client device 104, a UI element prompting the user to enter user credentials for the user account they wish to access. The UI element may be a login page with input fields in which the user may enter a username and password associated with their user account with service 108A.

At 206, application 106A on client device 104 may send the user credentials provided by the user to service 108A. Service 108A may authenticate the user and client device 104 using the credentials provided. In some embodiments, application 106A may also send, along with the user credentials, a flag indicating that client device 104 is the user’s personal device and thus the device ID for client device 104 may be linked with the user account upon authentication. Accordingly, service 108A may update the user account information to include the unique device ID for client device 104 allowing service 108A to identify the user account using the device ID for subsequent requests to access the user account using client device 104.

At 208, upon authenticating the user and client device 104, service 108A may send a request to CAP 102 to generate an authentication token for client device 104 based on the authentication. The request may include the device ID for client device 104, an indication that successful authentication of user and client device 104 has been performed by service 108A, and the method of authentication used. For example, the method of authentication may be a username and password login for the authentication described above. However, service 108A may have used any one or more of several qualifying authentication methods to authenticate the user and client device 104. Examples of qualifying authentication methods may include, but are not limited to, biometric scans (e.g., fingerprint scan, facial recognition, and retina scan), PIN code, geolocation, voice detection, and physical security key. In some embodiments, the request may also include the username and/or email associated with the user’s account with service 108A.

At 210, CAP 102 may determine an authorization level for client device 104 based on the authentication method used to authenticate client device 104. The authorization level may correspond with the level of security provided by an authentication method. For example, multi-factor authentication methods may be assigned a high authorization level, while low-security, single-factor authentication methods such as PIN code and geolocation may be assigned a low authorization level.

CAP 102 may generate an authentication token for client device 104 based on the authorization level of client device 104. CAP 102 may store the authorization token for client device 104 in a secure token database, along with the device ID for client device 104 and the token information associated with the generated token. The token information may include, for example, a token ID, authorization level, and a timestamp indicating when the token was created. In some embodiments, the token information may also include the username and/or email associated with the user account.

At 212, CAP 102 may send the authentication token to client device 104. Client device 104 may store the authentication token in a secure location on the device fully accessible only to CAP 102. Applications 106 may have access to detect whether or not an authentication token exists in the storage location. However, only CAP 102 may have read and write permissions for the storage location of the authentication token on client device 104.

At 214, CAP 102 may send a response to service 108A indicating that an authentication token has been generated for client device 104 and is valid for the user.

At 216, service 108A may send an indication to application 106A on client device 104 that successful authentication of the user and client device 104 has been performed, allowing the user to access their account on client device 104 using application 106A.

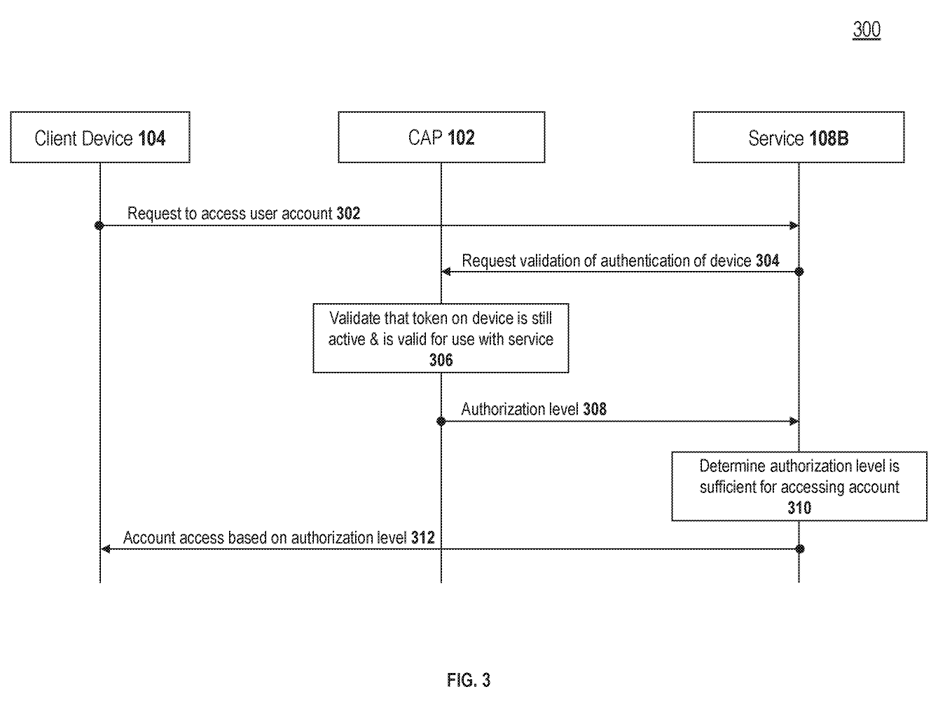

FIG. 3 illustrates a process 300 for validating authentication of a user for a participating service using a centralized authentication platform (e.g., CAP 102) when a token has previously been generated for the user device, in accordance with some embodiments. Process 300 may be performed by processing logic that may include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, the steps in FIG. 3 may not need to be performed in the exact order shown, as will be understood by a person of ordinary skill in the art. Accordingly, the scope of the invention should not be considered limited to the specific arrangement of steps shown in FIG. 3.

Process 300 shall be described with reference to FIG. 1. However, process 300 is not limited to that example embodiment.

At 302, application 106B installed on client device 104 may send a request to access a user account to service 108B. The request may include the device ID for client device 104 and an indication that an authentication token generated by CAP 102 exists on client device 104. In some embodiments, client device 104 may be the user’s personal device and thus associated with a particular user account for the user. As such, service 108B may use the device ID for client device 104 to identify the user account associated with client device 104.

However, if client device 104 is associated with more than one user account for service 108B, application 106B may be configured to display a UI element prompting the user to select the account they would like to access before sending a request to service 108B. The UI element may display a list comprising a username for each account associated with client device 104. Each username may be a selectable element. Upon selection of a username associated with the particular user account for which the user desires to request access, application 106B may send a request to service 108B to access the selected user account. The request may include the device ID for client device 104 and the username associated with user account for which the application 106B is requesting access.

At 304, service 108B may send a request to CAP 102 to validate the authentication token stored on client device 104. The request may include the device ID for client device 104. In some embodiments, the request may also include a time period for which the authentication token is be considered active by service 108B. For example, service 108B may trust authentication of a user on client device 104 for 48 hours. As such, if the authentication token on client device was generated more 48 hours prior to the request to validate the token, the authentication token is no longer valid for service 108B. Accordingly, the user will be required to re-authenticate on client device 104 in order to gain access to the user account.

At 306, CAP 102 may identify and retrieve, from the token database, the authentication token for client device 104 using the device ID. CAP 102 may also retrieve the authentication token stored on client device 104. CAP 102 may then validate that the authentication token on the client device is valid by matching the authentication token stored on client device 104 to the authentication token for client device 104 retrieved from the token database.

In some embodiments, client device 104 may be associated with two or more user accounts maintained by service 108B. As such, service 108B may need to ensure that the authentication token is valid for authentication of the correct user account. Accordingly, service 108B may include, in the request to CAP 102 to validate the authentication token stored on client device 104, the username/email of the account for which service 108B is requesting validation of the token. In this scenario, CAP 102 may use the username/email for the user account in addition to the device ID to identify and retrieve the authentication token for client device 104 from the token database.

In some embodiments, CAP 102 may determine an expiration date and time for the authentication token based on the token creation timestamp in the token information and the token expiration time for service 108B. CAP 102 may then validate that the authentication token is still active and has not expired.

At 308, CAP 102 may send a response to service 108B indicating that the authentication token on client device 104 is valid for authenticating the user and client device for service 108B. The response may also include the authorization level of the authentication token for client device 104.

At 310, upon receiving the response from CAP 102, service 108B may determine that the authorization level of the authentication token for client device 104 is equal to or greater than that required for accessing a user account.

At 312, service 108B may grant permission to access the user account using application 106B on client device 104 based on validation of the authentication token on client device 104.

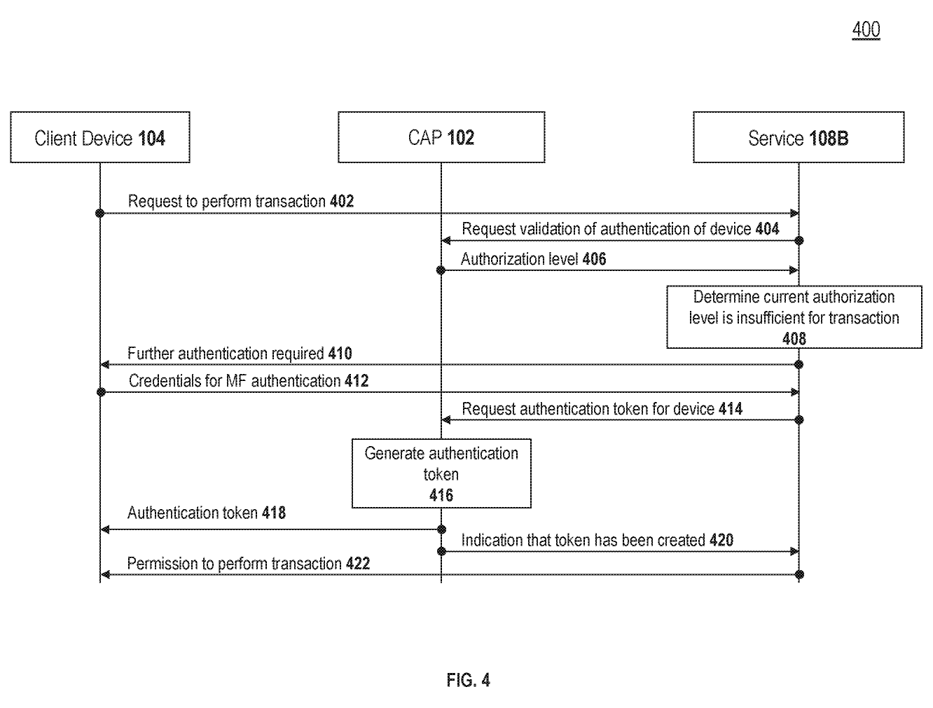

FIG. 4 illustrates a sequence diagram illustrating a process for re-authenticating a user with a participating service using a centralized authentication platform (e.g., CAP 102) when a previously-generated token is insufficient for the level of service requested, in accordance with some embodiments. Process 400 may performed by processing logic that may include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, the steps in FIG. 4 may not need to be performed in the exact order shown, as will be understood by a person of ordinary skill in the art. Accordingly, the scope of the invention should not be considered limited to the specific arrangement of steps shown in FIG. 4.

Process 400 shall be described with reference to FIG. 1. However, process 400 is not limited to that example embodiment.

At 402, application 106B on client device 104 may send a request to service 108B to perform a transaction. The request may include the device ID for client device 104 and an indication that an authentication token generated by CAP 102 exists on client device 104. In some embodiments, service 108B may use the device ID for client device 104 to identify the user account associated with client device 104.

At 404, service 108B may send a request to CAP 102 to validate the authentication token stored on client device 104. The request may include the device ID for client device 104. In some embodiments, the request may also include a token expiration time and/or the username/email of the user account for which service 108B is requesting validation of the authorization token. CAP 102 may retrieve the authentication token stored on client device 104 and validate that the token is valid by matching it to the authentication token for client device 104 retrieved from the token database.

At 406, CAP 102 may send a response to service 108B indicating that the authentication token on client device 104 is valid for authenticating the user and client device for service 108B. The response may also include the authorization level of the authentication token for client device 104.

At 408, service 108B may determine that the authorization level of the authentication token for client device 104 is lower than the authorization level required to perform the transaction. For example, service 108B may be an online banking service and the user may have requested to make a transfer to an external account. Service 108B may require an authorization level corresponding to a multifactor authentication method to perform transactions that require transfers to external accounts. However, the authorization level of the authentication token for client device 104 may correspond to a username and password login method of authentication. As such, service 108B may require further authentication of the user and client device 104 via multifactor authentication in order to allow the user to perform the transaction.

At 410, service 108B may send a response to application 106B on client device 104 indicating that further authentication is required to perform the transaction. The response may include instructions for a multifactor authentication process. Application 106B may be configured to display, on client device 104, a UI element that provides instructions/steps to the user for performing the required multifactor authentication. In some embodiments, the UI element may provide input fields for user credentials and/or onetime passwords which the user may retrieve, for example, via an authenticator application, keyfob, or SMS.

At 412, application 106B may send the information (e.g., credentials) provided by the user, based on the instructions for the multifactor authentication process from service 108B, to service 108B. Service 108B may successfully authenticate the user and client device based on the information from application 106B.

At 414, service 108B may send a request to CAP 102 to generate an authentication token for client device 104 based on the multifactor authentication. The request may include the device ID for client device 104, an indication of successful authentication of user and client device 104, and the method of authentication used for the authentication. In some embodiments, the request may also include the username and/or email associated with the user’s account with service 108B.

At 416, CAP 102 may determine an updated authorization level for client device 104 based on the multifactor authentication method used to authenticate client device 104. CAP 102 may generate a new authentication token for client device 104 based on the updated authorization level. CAP 102 may replace the existing authentication token and token information for client device 104 in the token database with the newly generated authentication token and token information.

At 418, CAP 102 may send the newly generated authentication token to client device 104. Upon receiving the new token, client device 104 may replace the existing authentication token with the new authentication token from CAP 102.

At 420, CAP 102 may send a response to service 108B indicating that a new authentication token has been generated for client device 104 based on the multifactor authentication performed by service 108B.

At 422, service 108B may send an indication to application 106B on client device 104 that successful authentication of the user and client device 104 has been completed, allowing the user to proceed with performing the transaction on client device 104 using application 106B.

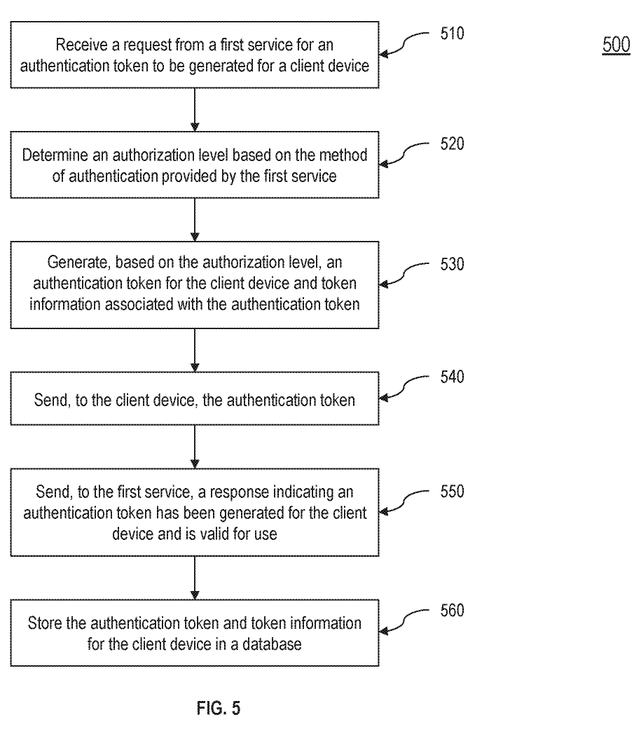

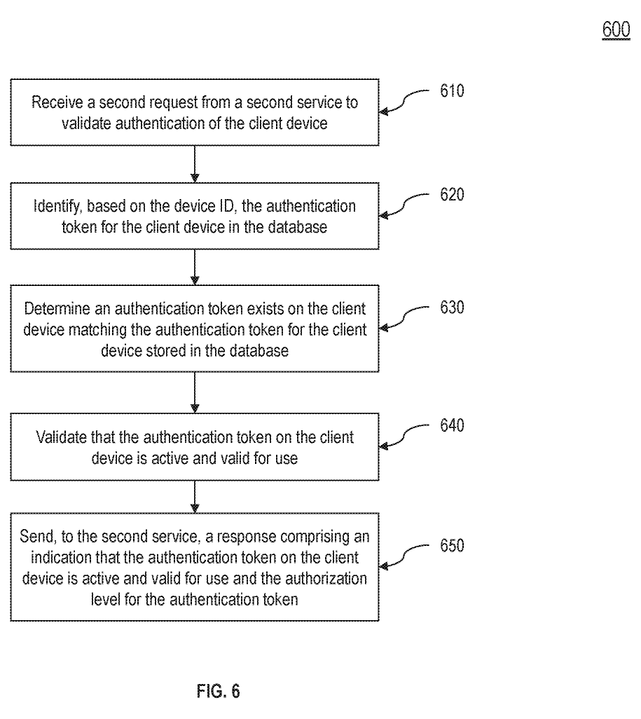

FIG. 5 and 6 illustrate methods 500 and 600 for authenticating a user with and validating authentication of a user for a participating service using a centralized authentication platform (e.g., CAP 102), in accordance with some embodiments. Methods 500 and 600 may be performed by processing logic that may include hardware (e.g., circuitry, dedicated logic, programmable logic, microcode, etc.), software (e.g., instructions executing on a processing device), or a combination thereof. In some embodiments, some steps in FIG. 5 and 6 may not need to be performed in the exact order shown, as will be understood by a person of ordinary skill in the art. Accordingly, the scope of the invention should not be considered limited to the specific arrangement of steps shown in FIG. 5 and 6.

Referring now to FIG. 5, method 500 shall be described with reference to FIG. 1. However, method 500 is not limited to those example embodiments.

In 510, CAP 102 may receive a request from a service 108A for an authentication token to be generated for client device 104 based on authentication of the client device performed by service 108A. The request may include an indication of successful authentication, a unique device ID for client device 104, and a qualifying method of authentication. The method of authentication may be the method by which the user and client device 104 was authenticated by service 108A.

In 520, CAP 102 may determine an authorization level for the authentication of the user and client device 104 based on the method of authentication provided in the request. The authorization level may correspond to the level of security provided by the authentication method.

In 530, CAP 102 may generate an authentication token for client device 104 based on the authentication of the user and client device 104 performed by service 108A. The authentication token may be assigned the authorization level determined by CAP 102 in 520. As such, the newly generated authentication token may be used to authenticate the user and client device 104 with other participating services requiring an authorization level lower than or equal to the authorization level assigned to the token.

In addition to the authentication token, CAP 102 may also generate token information associated with the authentication token for client device 104. The token information may include the authorization level of the token, a token ID, and a timestamp indicating the date and time when the token was generated.

In 540, CAP 102 may send the authentication token to client device 104 over a secure connection. Upon receiving the authentication token, client device 104 may verify that the authentication token was sent by CAP 102 and store the token in a secure location. CAP 102 may have read and write permissions for the authentication token storage location on client device 104, while participating services may have limit read permission that allows services to simply detect the presence of a token.

In 550, CAP 102 may send a response to service 108A. The response may indicate that an authentication token for client device 104 has been generated and sent to client device 104.

In 560, CAP 102 may store the authentication token for client device 104 and associated token information in a secure token database. The token database may be a searchable database such that CAP 102 may search for and retrieve authentication tokens for a given client device using the client device ID.

Referring now to FIG. 6, method 600 shall be described with reference to FIG. 1. However, method 600 is not limited to those example embodiments.

In 610, CAP 102 may receive a request from service 108B to validate authentication of client device 104 based on the authentication token stored on client device 104. The request may include the device ID for client device 104. In some embodiments, the request may also include a token expiration time and an email/username associated with the user for which service 108B requires authentication. The request to CAP 102 may have been sent by service 108B in response to receiving a separate request from client device 104 to access a user account maintained by service 108B using application 106B.

In 620, CAP 102 may query the token database using the device ID provided in the request and retrieve the authentication token for client device 104. In some embodiments, CAP 102 may query the token database using both the device ID and email/username. This may be useful if the user has multiple accounts with a participating service and uses client device 104 to log into two or more of those accounts.

In 630, CAP 102 may communicate with client device 104 to determine that an authentication token exists on the device and validate the token against the authentication token for client device 104 retrieved from the token database. Validation of the authentication token on client device 104 may include may include determining that it matches the authentication token retrieved from the token database.

In 640, CAP 102 may use the timestamp in the token information indicating when the authentication token for client device 104 was generated and the token expiration time for service 108B, to determine that the authentication token is active and has not expired. As described above, the token expiration time for service 108B may be included in the request to validate authentication of client device 104. Alternatively, the token expiration times for participating services may be stored in a database (separate from the token database) and retrieved by CAP 102 using a service ID unique to each participating service.

In 650, CAP 102 may send, to service 108B, a response indicating that the authentication token stored on client device 104 is active and valid for authentication of the user and client device with service 108B. Additionally, the response may include the authorization level of the authentication token for client device 104. Upon receiving the response, service 108B may determine that the authorization level provided in the response is equal to or greater than the authorization level required to access a user account. Having determined that the authorization level is sufficient, service 108B may grant permission to client device 104 to access the user account using application 106B.

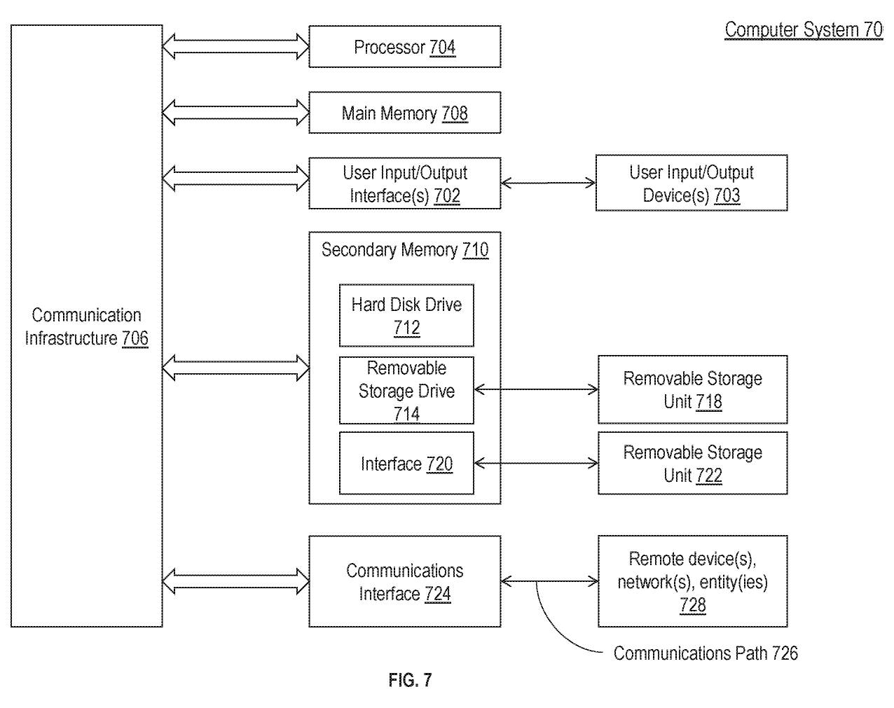

Various embodiments may be implemented, for example, using one or more well-known computer systems, such as a computer system 700, as shown in FIG. 7. One or more computer systems 700 may be used, for example, to implement any of the embodiments discussed herein, as well as combinations and sub-combinations thereof. The computer systems 700 may be used for the implementation of one or more embodiments described above.

The computer system 700 may include one or more processors (also called central processing units, or CPUs), such as a processor 704. The processor 704 may be connected to a communication infrastructure or bus 706.

The computer system 700 may also include user input/output device(s) 703, such as monitors, keyboards, pointing devices, etc., which may communicate with communication infrastructure 706 through user input/output interface(s) 702.

One or more processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

The computer system 700 may also include a main or primary memory 708, such as random access memory (RAM). Main memory 708 may include one or more levels of cache. Main memory 708 may have stored therein control logic (i.e., computer software) and/or data.

The computer system 700 may also include one or more secondary storage devices or memory 710. The secondary memory 710 may include, for example, a hard disk drive 712 and/or a removable storage device or drive 714. The removable storage drive 714 may be a floppy disk drive, a magnetic tape drive, a compact disk drive, an optical storage device, tape backup device, and/or any other storage device or storage drive.

The removable storage drive 714 may interact with a removable storage unit 718. The removable storage unit 718 may include a computer-usable or readable storage device having stored thereon computer software (control logic) and/or data. The removable storage unit 718 may be a floppy disk, magnetic tape, compact disk, DVD, optical storage disk, and/ any other computer data storage device. The removable storage drive 714 may read from and/or write to the removable storage unit 718.

The secondary memory 710 may include other means, devices, components, instrumentalities, or other approaches for allowing computer programs and/or other instructions and/or data to be accessed by the computer system 700. Such means, devices, components, instrumentalities, or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

The computer system 700 may further include a communication or network interface 724. The communication interface 724 may enable the computer system 700 to communicate and interact with any combination of external devices, external networks, external entities, etc. (individually and collectively referenced by reference number 728). For example, the communication interface 724 may allow the computer system 700 to communicate with the external or remote devices 728 over communications path 726, which may be wired and/or wireless (or a combination thereof), and which may include any combination of LANs, WANs, the Internet, etc. Control logic and/or data may be transmitted to and from the computer system 700 via the communication path 726.

The computer system 700 may also be any of a personal digital assistant (PDA), desktop workstation, laptop or notebook computer, netbook, tablet, smartphone, smartwatch or other wearable, appliance, part of the Internet-of-Things, and/or embedded system, to name a few non-limiting examples, or any combination thereof.

The computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in the computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, or schemas may be used, either exclusively or in combination with known or open standards.

In accordance with some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, the computer system 700, the main memory 708, the secondary memory 710, and the removable storage units 718 and 722, as well as tangible articles of manufacture embodying any combination of the foregoing. Such control logic, when executed by one or more data processing devices (such as the computer system 700), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 6. In particular, embodiments can operate with software, hardware, and/or operating system implementations other than those described herein.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments but should be defined only in accordance with the following claims and their equivalents.

What is claimed is:

1. A computer-implemented method, comprising:
receiving, by one or more computing devices and from a first service, a first request to validate authentication of a client device, the first request comprising:
(a) a unique device identifier of the client device,
(b) a first transaction type for which validation of the client device is required, and
(c) an indication that a first authentication token is present on the client device;
validating, by the one or more computing devices and based on the unique device identifier of the client device, the first authentication token, wherein the first authentication token corresponds to a second authentication token stored in a token database; and
transmitting, by the one or more computing devices to the first service, a response indicating the first authentication token is active and valid for use.

2. The computer-implemented method of claim 1, wherein the first authentication token corresponds to a prior successful authentication of the client device by a second service.

3. The computer-implemented method of claim 2, wherein the prior successful authentication includes a method of authentication associated with a first authorization level.

4. The computer-implemented method of claim 3, wherein validating the first authentication token comprises:
retrieving, by the one or more computing devices and from a services database, data for the first service comprising a second authorization level required for the first transaction type; and
determining, by the one or more computing devices, the first authentication token is valid for use based on the first authorization level being equal to or greater than the second authorization level.

5. The computer-implemented method of claim 3, wherein the first authentication token is associated with a creation timestamp and a duration of time based on the first authorization level, and wherein validating the first authentication token comprises:
determining, by the one or more computing devices, the first authentication token is active based on the creation timestamp and the duration of time.

6. The computer-implemented method of claim 1, wherein the first transaction type is one of a plurality of transaction types for the first service, and wherein each transaction type of the plurality of transaction types is associated with a corresponding authorization level required to perform a corresponding transaction categorized under the respective transaction type.

7. The computer-implemented method of claim 1, further comprising:
receiving, by the one or more computing devices from the first service, a second request to validate authentication of the client device, the second request comprising:
(a) the unique device identifier of the client device,
(b) a second transaction type for which validation of the client device is required, and
(c) the indication that the first authentication token is present on the client device;
determining, by the one or more computing devices, that the first authentication token is not valid for use to perform the second transaction type; and
transmitting, by the one or more computing device and to the first service, a second response indicating that the first authentication token is not valid for use to perform the second transaction type.

8. A computer-implemented method, comprising:
receiving, by one or more computing devices and from a client device, an access request to access a user account;
transmitting, by the one or more computing devices and to a centralized authentication platform (CAP), a first request to validate authentication of the client device, the first request comprising:
(a) a unique device identifier of the client device,
(b) a first transaction type for which validation of the client device is required, and
(c) an indication that a first authentication token is present on the client device;
receiving, by the one or more computing devices and from the CAP, a response indicating the first authentication token is active and valid for use based on the CAP performing validation of the first authentication token, wherein the validation is based on the unique device identifier of the client device, and wherein the first authentication token corresponds to a second authentication token stored in a token database of the CAP; and
granting, by the one or more computing devices to the client device, access to the user account based on the response.

9. The computer-implemented method of claim 8, wherein the first authentication token corresponds to a prior successful authentication of the client device by a first service.

10. The computer-implemented method of claim 9, wherein the prior successful authentication includes a method of authentication associated with a first authorization level.

11. The computer-implemented method of claim 10, wherein the first authentication token is valid for use based on the first authorization level being equal to or greater than a second authorization level required for the first transaction type.

12. The computer-implemented method of claim 10, wherein the first authentication token is associated with a creation timestamp and a duration of time based on the first authorization level, and wherein the first authentication token is active based on the creation timestamp and the duration of time.

13. The computer-implemented method of claim 8, wherein the first transaction type is one of a plurality of transaction types for the first service, and wherein each transaction type of the plurality of transaction types is associated with a corresponding authorization level required to perform a corresponding transaction categorized under the respective transaction type.

14. The computer-implemented method of claim 8, further comprising:
receiving, by the one or more computing devices and from the client device, a second access request to access a second user account;
transmitting, by the one or more computing devices to the CAP, a second request to validate authentication of the client device, the second request comprising:
(a) the unique device identifier of the client device,
(b) a second transaction type for which validation of the client device is required, and
(c) the indication that the first authentication token is present on the client device; and
receiving, by the one or more computing device and from the CAP, a second response indicating that the first authentication token is not valid for use to perform the second transaction type.

15. A computer-implemented method, comprising:
transmitting, by a client device and to a first service, an access request to access a user account, the access request comprising:
(a) a unique device identifier of the client device,
(b) a first transaction type for which validation of the client device is required, and
(c) an indication that a first authentication token is present on the client device;
receiving, by the client device and from the first service, permission to access the user account based on the first authentication token being active and valid for use, wherein the first authentication token is active and valid for use based on validation performed by a central authentication platform (CAP), wherein the validation is based on the unique device identifier of the client device, and wherein the first authentication token corresponds to a second authentication token stored in a token database of the CAP; and
accessing, by the client device, the user account based on the receiving.

16. The computer-implemented method of claim 15, wherein the first authentication token corresponds to a prior successful authentication of the client device by a second service.

17. The computer-implemented method of claim 16, wherein the prior successful authentication includes a method of authentication associated with a first authorization level.

18. The computer-implemented method of claim 17, wherein the first authentication token is valid for use based on the first authorization level being equal to or greater than a second authorization level required for the first transaction type.

19. The computer-implemented method of claim 17, wherein the first authentication token is associated with a creation timestamp and a duration of time based on the first authorization level, and wherein the first authentication token is active based on the creation timestamp and the duration of time.

20. The computer-implemented method of claim 16, wherein the first transaction type is one of a plurality of transaction types for the first service, and wherein each transaction type of the plurality of transaction types is associated with a corresponding authorization level required to perform a corresponding transaction categorized under the respective transaction type.
